(19) United States
(12) Patent Application Publication
(10) Pub. No.: US 2003/0124406 A1
(43) Pub. Date: Jul. 3, 2003

(54) Fuel cell separator

(75) Inventors: Teruyuki Ohtani, Wako-shi (JP); Makoto Tsuji, Wako-shi (JP); Masao Utsunomiya, Wako-shi (JP); Koji Kotani, Wako-shi (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: HONDA GIKEN KOGYO KABUSHIKI KAISHA

(21) Appl. No.: 10/326,404

(22) Filed: Dec. 23, 2002

(30) Foreign Application Priority Data
Dec. 25, 2001 (JP) 2001-392215

(51) Int. Cl. H01M 8/02; B32B 3/00; B32B 15/04

(52) U.S. Cl. 429/34; 428/469; 428/457

(57) ABSTRACT

A fuel cell separator in which high electrical conductivity of an electricity generating portion and high corrosion resistance of an non-electricity generating portion are combined. The fuel cell separator, comprising the electricity generating portion and the non-electricity generating portion, wherein a material of at least a surface of one of the portions is different from that of a surface of other portions.

### BACKGROUND OF THE INVENTION

1. Field of the Invention

The present invention relates to a separator provided in a solid polymer fuel cell.

2. Description of the Related Art

In a solid polymer fuel cell, a laminated body, in which, on both sides of a planar MEA (Membrane Electrode Assembly), a separator is laminated, is regarded as one unit, and plural units are stacked and form a fuel cell stack. The MEA is formed as a three layer structure in which, between a pair of gas diffusion electrodes that constitute a cathode and an anode, an electrolyte membrane made of, for example, an ion exchange resin or the like, is interposed. In the gas diffusion electrode, outside of an electrode catalyst layer in contact with an electrolyte membrane, a gas diffusion layer is formed. Furthermore, the separator, laminated so as to come into contact with the gas diffusion electrode of the MEA, is provided with a gas passage that allows a gas to flow and a coolant passage between the separator and the gas diffusion electrode. According to such a fuel cell, for instance when a hydrogen gas as a fuel is allowed to flow in the gas passage facing the gas diffusion electrode on the anode side, and an oxidizing gas such as oxygen or air is allowed flowing in the gas passage facing the gas diffusion electrode on the cathode side, there occurs an electrochemical reaction, resulting in the generation of electricity.

The separator must function so that, while supplying electrons generated at the anode side according to a catalytic reaction of the hydrogen gas to an external circuit, electrons from the external circuit may be supplied to the cathode side. Accordingly, for the separator, a conductive material made of a graphite based material or a metal based material is used, and in particular the metal based material is regarded as being advantageous in view of superiority in mechanical strength and in ability to be made lighter and more compact by being formed into a thin plate. As a metal separator, one in which, for instance, a thin plate of stainless steel on a surface of which conductive inclusions that form a conductive passage are dispersed and exposed, is press-molded into a corrugated shape in cross section can be cited.

In such a metal separator, a portion that is formed into a corrugated shape in cross section is regarded as an electricity generating portion, and usually in the surroundings thereof, a flat flange-like non-electricity generating portion is integrally formed. In the electricity generating portion formed into the corrugated shape in cross section, a groove and a projection are alternately formed, the groove constitutes a gas passage or a coolant passage, and the projection is brought into contact with the gas diffusion electrode of the MEA. Furthermore, in the non-electricity generating portion, for instance, a supply opening or an exhaust opening of a fuel gas or the like is disposed, or a hole for a coolant passage is formed.

In the conventional metal separator like the one that has the electricity generating portion and the non-electricity generating portion, the non-electricity generating portion is preferably to be corrosion resistant, and on the other hand, the electricity generating portion must have electrical conductivity rather than corrosion resistance in view of reducing contact resistance with the MEA and thereby improving electrical conductivity, and thereby improving electricity generating capability. Accordingly, when manufacturing the separator, measures either sacrificing the electrical conductivity of the electricity generating portion by raising the corrosion resistance as a whole in order to secure the corrosion resistance of the non-electricity generating portion, or sacrificing the corrosion resistance of the non-electricity generating portion by lowering the corrosion resistance as a whole, and thereby improving the electricity generating performance of the electricity generating portion, have to be taken.

### SUMMARY OF THE INVENTION

Accordingly, the present invention intends to provide a fuel cell separator that can successfully combine high electrical conductivity of the electricity generating portion and high corrosion resistance of the non-electricity generating portion.

A fuel cell separator according to the present invention comprises an electricity generating portion and a non-electricity generating portion, and at least a surface of the one of the portions is different from that of the other. In the present invention, by appropriately selecting materials of at least the surfaces of the electricity generating portion and the non-electricity generating portion, electrical conductivity of the electricity generating portion can be improved and the non-electricity generating portion can be endowed with corrosion resistance incompatible with the electrical conductivity.

The present invention includes a mode in which at least both surfaces of the electricity generating portion and the non-electricity generating portion are made of a material having corrosion resistance, and in addition to the above, the surface of the electricity generating portion has electrical conductivity. Such a configuration can be realized by use of, for instance, a stainless steel plate. That is, since the stainless steel plate itself has an oxide film on a surface thereof, it has corrosion resistance. Accordingly, by applying a type of surface treatment that can reduce the corrosion resistance only of the electricity generating portion and thereby differentiating the material from that of the surface of the non-electricity generating portion, the electricity generating portion can be provided with the electrical conductivity.

Furthermore, the present invention includes another mode in which the entirety of the separator is made of a metal having conductive inclusions in a metal texture, a surface of an electricity generating portion is processed so that the conductive inclusions are exposed, and a surface of a non-electricity generating portion is provided with an oxide film or a passivation film. Also in a configuration like this, the stainless steel plate can be preferably applied. For instance, a separator is formed of a stainless steel plate having conductive inclusions in a metal texture, and a base metal of a surface of the electricity generating portion is removed to expose the conductive inclusions on the surface thereof. Thereby, a separator of the present invention can be obtained. In the electricity generating portion, the conductive inclusions, projected on the surface, function effectively as a conductive passage of electricity, thereby reducing contact resistance with the MEA, resulting in an improvement in the electricity generating capability. A surface of the non-electricity generating portion is provided with an oxide film or a passivation film, resulting in sufficiently ensuring the corrosion resistance.

In the present invention, even when a hybrid structure in which an electricity generating portion and a non-electricity generating portion are utterly different in material is adopted, effects of the present invention can be obtained. Specifically, a configuration in which the electricity generating portion is made of a metal and the non-electricity generating portion is made of a resin can be cited. In this case, by connecting the non-electricity generating portion made of a resin having the corrosion resistance to the metallic electricity generating portion having the electrical conductivity, a separator of the present invention can be obtained. As a method of connecting the two, for instance, a resin-molding method can be used.

### BRIEF DESCRIPTION OF THE DRAWINGS

FIG. 1 is a plan view of a separator according to one embodiment of the present invention;

FIG. 2 is a partial sectional view of the separator according to the embodiment;

FIG. 3 is a plan view of a separator according to another embodiment of the present invention; and

FIG. 4 is a partial sectional view of the separator according to another embodiment.

### DESCRIPTION OF THE PREFERRED EMBODIMENTS

In the following, with reference to the drawings, one embodiment of the present invention will be explained.

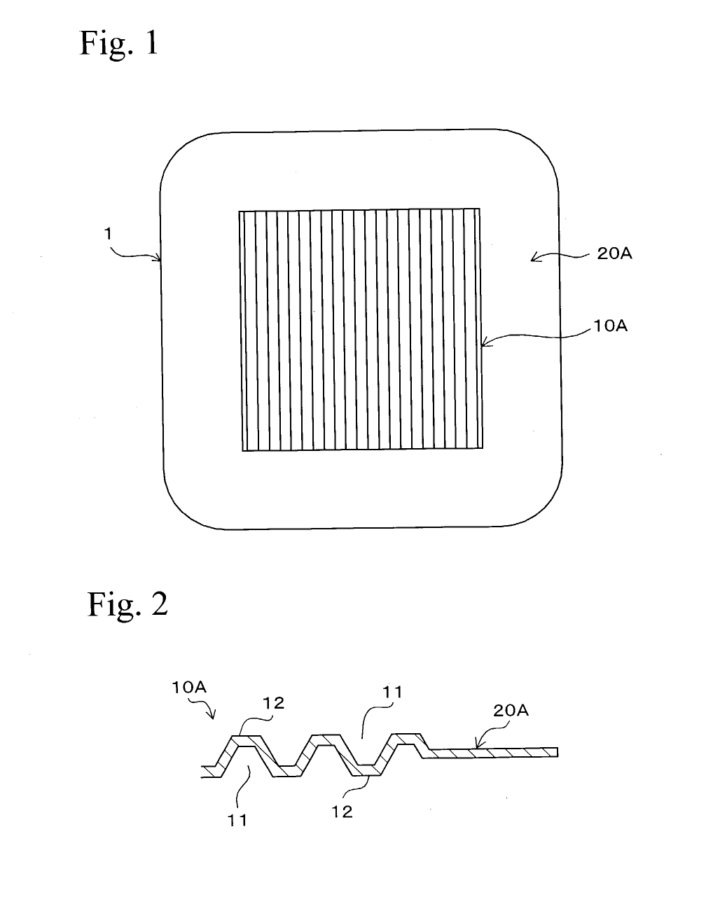

FIG. 1 is a drawing showing a square metal separator according to one embodiment of the present invention. A separator 1 is obtained by press-molding a thin plate made of stainless steel, in a center portion of which a square electricity generating portion 10A is formed, and in the surroundings of the electricity generating portion 10A a flange like non-electricity generating portion 20A is formed. As shown in FIG. 2, the electricity generating portion 10A exhibits a corrugated shape in which concavities and convexities are trapezoidal in contour in cross section are repeated in a plane direction, and the non-electricity generating portion 20A is formed so as to be tabular. In the electricity generating portion 10A, grooves on both surfaces thereof are regarded as gas passage 11, and a surface of a projected portion 12 between the grooves is brought into contact with a gas diffusion electrode of an MEA (not shown).

The stainless steel plate that is a material of the separator 1 has conductive inclusions in a metal texture thereof, and the conductive inclusions project at a surface of the electricity generating portion 10A (here, both front and back surfaces are collectively called a surface). The conductive inclusions effectively function as a conductive passage. On the other hand, on a surface of the non-electricity generating portion 20A, in a state of the material as it is, an oxide film is formed.

As the stainless steel plate that is a material of the separator 1, one that has, for instance, the following components in the following ranges, is preferable. That is, C: 0.15% or less by weight; Si: 0.01 to 1.5% by weight; Mn: 0.01 to 2.5% by weight; P: 0.035% or less by weight; S: 0.01% or less by weight; Al: 0.001 to 0.2% by weight; N: 0.3% or less by weight; Cu: 0 to 3% by weight; Ni: 7 to 50% by weight; Cr: 17 to 30% by weight; Mo: 0 to 7% by weight; and balance: Fe, B and unavoidable impurities; and Cr, Mo and B satisfying the following equation

Cr(wt %)+3×Mo(wt %)−2.5×B(wt %)≧17.

According to the stainless steel plate, B is precipitated as a boride of M₂B and MB types, and a boride of M₂₃(C, B)₆ type on a surface thereof, the borides being the conductive inclusions.

Next, an example of a manufacturing method of the separator 1 will be explained.

(1) Rolling

In order to obtain a stainless steel plate having a predetermined thickness (for instance, 0.2 mm), cold rolling and bright annealing are repeated. Usually, the bright annealing is performed by heating in an inert gas such as an ammonia decomposition gas or a gas mixture of H₂+N₂ at a predetermined temperature for a predetermined period of time, and in order to prevent an oxide film from being formed on a surface, it is performed in an atmosphere where oxygen is not present. However, in the present invention, in order to form an oxide film that is superior in corrosion resistance on a surface of the stainless steel plate, the bright annealing is performed, by adding a small amount of oxygen to an inert N₂ atmosphere, in an atmosphere where a small amount of oxygen is present. For instance, when the bright annealing is performed under an oxygen partial pressure of 0.001 atmosphere and a nitrogen partial pressure of 0.999 atmosphere, an oxide film of superior corrosion resistance can be formed.

(2) Next, a material cut into a predetermined dimension is press-molded, and thereby a separator material having the electricity generating portion 80A and the non-electricity generating portion 20A is obtained.

(3) Subsequently, only on a surface of the electricity generating portion 10A, a process is performed to allow the conductive inclusions to project from the surface of the electricity generating portion 10A. As a surface treatment for allowing the conductive inclusions to project, a method for removing the base material on the surface such as electrochemical methods such as electrolytic etching or the like, chemical methods such as etching or the like, and physical methods such as polishing, sand blasting or the like can be cited.

According to the above method, the surface of the electricity generating portion 10A has the conductive inclusions projected there from and has high electrical conductivity. On the other hand, the surface of the non-electricity generating portion 20A shows high corrosion resistance since the oxide film remains as it is. When the corrosion resistance of the non-electricity generating portion 20A is intended to be further improved, a method can be cited in which, with the electricity generating portion 10A masked, only the surface of the non-electricity generating portion 20A is subjected to a passivation process, thereby forming a passivation film on the surface of the non-electricity generating portion 20A. The passivation process can be applied by immersing in an acidic solution.

According to the above separator 1, the surface of the electricity generating portion 10A has reduced contact resistance with the MEA because of the projected conductive inclusions, and has high electrical conductivity. On the other hand, the surface of the non-electricity generating portion 20A shows high corrosion resistance because of the formation of the oxide film. Accordingly, high electrical conductivity of the electricity generating portion 10A and high corrosion resistance of the non-electricity generating portion 20A are combined.

Next, another embodiment of the present invention will be explained.

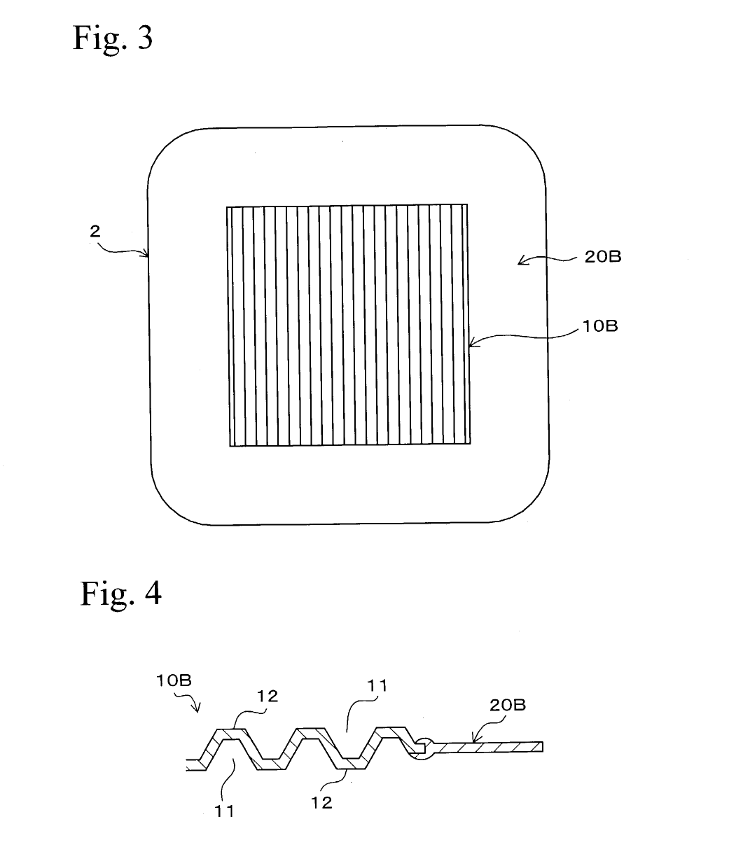

FIG. 3 is a drawing showing a separator according to another embodiment. The basic configuration of a separator 2 is the same as that of the separator 1 and has an electricity generating portion 10B and a non-electricity generating portion 20B. Here, in the electricity generating portion 10B, a stainless steel plate having conductive inclusions projected at a surface thereof is applied similarly to the separator 1. However the non-electricity generating portion 20B is formed by molding a resin. That is, in the separator 2, the electricity generating portion 10B is made of a metal and the non-electricity generating portion 20B is made of a resin, and both are combined into a hybrid structure. As a resin which constitutes the non-electricity generating portion 20B, for instance, phenolic resins or the like can be preferably used. As shown in FIG. 4, the non-electricity generating portion 20B made of the resin is molded simultaneously by resin molding to an outer periphery of the electricity generating portion 10B, thereby being integrated with the electricity generating portion 10B.

In the separator 2 according to the present embodiment, the electricity generating portion 10B, similarly to the first embodiment, has reduced contact resistance with the MEA because of the conductive inclusions projected at the surface thereof, and has high electrical conductivity. On the other hand, the non-electricity generating portion 20B is entirely made of the resin and shows high corrosion resistance. Accordingly, similarly to the separator 1 according to the above embodiment, high electrical conductivity of the electricity generating portion 10B and high corrosion resistance of the non-electricity generating portion 20B are combined.

What is claimed is:

1. A fuel cell separator, comprising an electricity generating portion and a non-electricity generating portion, wherein a material of at least a surface of one of the portions is different from that of a surface of other portions.

2. The fuel cell separator according to claim 1,
wherein at least surfaces of the electricity generating portion and the non-electricity generating portion are made of a corrosion resistance material, and the surface of the electricity generating portion has electrical conductivity.

3. The fuel cell separator according to claim 2,
wherein an entirety of the fuel cell separator is made of a metal having conductive inclusions in a metal texture, a surface of the electricity generating portion is processed so as to project the conductive inclusions, and a surface of the non-electricity generating portion is provided with an oxide film or a passivation film.

4. The fuel cell separator according to claim 1,
wherein the electricity generating portion is made of a metal, and the non-electricity generating portion is made of a resin.
